(19) United States
(12) Patent Application Publication
(10) Pub. No.: US 2022/0322373 A1
(43) Pub. Date: Oct. 6, 2022

(54) MEASUREMENT TRIGGER METHOD AND APPARATUS, MEASUREMENT METHOD AND APPARATUS, BASE STATION AND USER EQUIPMENT

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/605,540

(22) PCT Filed: Apr. 24, 2019
(86) PCT No.: PCT/CN2019/084144

§ 371 Date: Oct. 21, 2021

(51) Int. Cl. H04W 72/12; H04W 48/10; H04W 68/00

(52) U.S. Cl. CPC H04W 72/1231; H04W 48/10; H04W 68/005

(57) ABSTRACT

A measurement triggering method, a measurement method, a base station, and a user equipment (UE) are provided. The measurement triggering method includes that the base station determines that there is a need for a UE to start a minimization of drive test (MDT) measurement; and the base station sends an MDT measurement triggering request through broadcast signaling to trigger the UE to perform the MDT measurement.

### CROSS REFERENCE TO RELATED APPLICATION

This application is the U.S. national phase application of International Application No. PCT/CN2019/084144 filed on Apr. 24, 2019, the entire contents of which are incorporated herein by reference for all purposes.

### TECHNICAL FIELD

The present disclosure relates to the field of communication technology, and in particular, to a measurement triggering method and device, measurement method and device, base station, user equipment, and computer-readable storage medium.

### BACKGROUND

A drive test is one of the most commonly used test methods for road wireless signals in the communications industry. The drive test may reflect a status of a network, may directly measure and evaluate network performance, and may point out a network problem. Traditional network optimization is based on drive test data. Network data such as level and quality is collected through a drive test instrument, the network problem is discovered by analyzing these data, and then network optimization is performed for the problem area. Such method often requires a lot of manpower, material resources, and financial resources, and also has very high experience requirements for network optimization personnel. A minimization of drive test (MDT) technology defined by the 3rd generation partnership project (3GPP) mainly uses a measurement report reported by a mobile phone to obtain a relevant parameter required for network optimization.

With the MDT technology, it may: 1) reduce drive test overhead and shorten optimization cycle, thereby reducing the cost of network optimization and maintenance of a mobile communication operator; 2) collect measurement information of the entire area that cannot be performed by the traditional drive test, such as the measurement information of a narrow road, forest and private place, therefore, the network performance can be evaluated more objectively, and the results of the network evaluation can be closer to the user experience, which brings higher user satisfaction; and 3) reduce traditional road measurement, thereby reducing carbon dioxide emissions and thus protecting the environment.

In order to make the MDT more effective, the application scenarios thereof currently mainly include coverage optimization, capacity optimization, mobile optimization, quality of service (QoS) guarantee and the like.

Currently, the MDT is initiated by operation administration and maintenance (OAM), and the activation of MDT functions that the OAM is responsible for includes: MDT activation based on management or area and MDT activation based on signaling.

### SUMMARY

The present disclosure provides a measurement triggering method and device, measurement method and device, base station, user equipment, and computer-readable storage medium.

A first aspect of the present disclosure provides a measurement triggering method, which is applied to a base station. The method includes: determining that there is a need for a user equipment (UE) to start a minimization of drive test (MDT) measurement; and sending an MDT measurement triggering request through broadcast signaling to trigger the UE to perform the MDT measurement.

A second aspect the present disclosure provides a measurement method, which is applied to a UE. The method includes: receiving an MDT measurement triggering request sent by a base station through broadcast signaling; and performing an MDT measurement in response to determining, according to the MDT measurement triggering request, that the UE needs to start the MDT measurement.

A third aspect of the present disclosure provides a base station. The base station includes a processor and a memory storing instructions that, when being executed by the processor, cause the processor to implement acts including: determining that there is a need for a UE to start an MDT measurement; and sending an MDT measurement triggering request through broadcast signaling to trigger the UE to perform the MDT measurement.

A fourth aspect of the present disclosure provides a UE. The UE includes a processor and a memory storing instructions that, when being executed by the processor, cause the processor to implement acts including: receiving an MDT measurement triggering request sent by a base station through broadcast signaling; and performing an MDT measurement in response to determining, according to the MDT measurement triggering request, that the UE needs to start the MDT measurement.

It should be understood that the above general description and the following detailed description are only exemplary and explanatory, which do not intend to limit the present disclosure.

### BRIEF DESCRIPTION OF THE DRAWINGS

The drawings here are incorporated into the specification and constitute a part of the specification, show embodiments that conform to the present disclosure, and are used together with the specification to explain the principle of the present disclosure.

FIG. 1 is a flowchart of a measurement triggering method shown in an embodiment of the present disclosure;

FIG. 2 is a flowchart of another measurement triggering method shown in an embodiment of the present disclosure;

FIG. 3 is a flowchart of a measurement method shown in an embodiment of the present disclosure;

FIG. 4 is a flowchart of another measurement method shown in an embodiment of the present disclosure;

FIG. 5 is a signaling flowchart of a measurement method shown in an embodiment of the present disclosure;

FIG. 6 is a block diagram showing a measurement triggering device according to an embodiment;

FIG. 7 is a block diagram showing another measurement triggering device according to an embodiment;

FIG. 8 is a block diagram showing another measurement triggering device according to an embodiment;

FIG. 9 is a block diagram showing another measurement triggering device according to an embodiment;

FIG. 10 is a block diagram showing another measurement triggering device according to an embodiment;

FIG. 11 is a block diagram showing a measurement device according to an embodiment;

FIG. 12 is a block diagram showing another measurement device according to an embodiment;

FIG. 13 is a block diagram showing a device suitable for measurement triggering according to an embodiment; and

FIG. 14 is a block diagram showing a device suitable for measurement according to an embodiment.

### DETAILED DESCRIPTION

Embodiments will be described in detail here, and examples thereof are shown in the accompanying drawings. When the following description is made by referring to the drawings, unless otherwise indicated, the same numbers in different drawings indicate the same or similar elements. The implementations described in the following embodiments do not represent all implementations in the present disclosure. Rather, they are merely examples of devices and methods in some aspects of the present disclosure as detailed in the appended claims.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

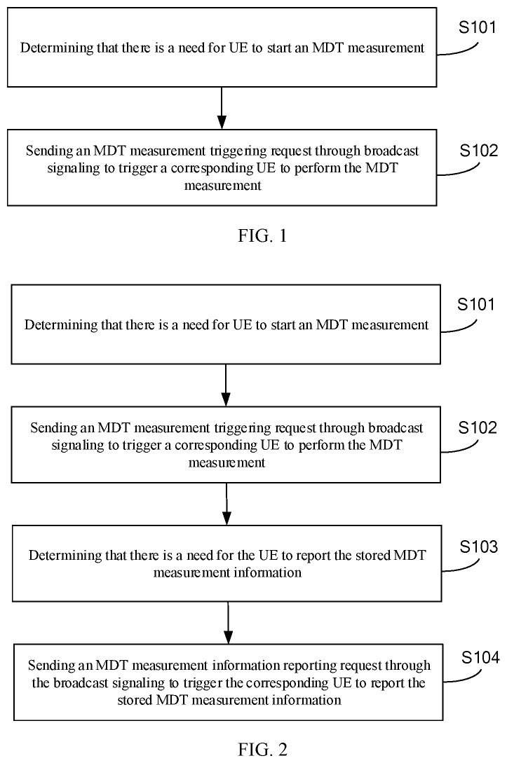

FIG. 1 is a flowchart of a measurement triggering method shown in an embodiment of the present disclosure. An embodiment is described from a base station side. As shown in FIG. 1, the measurement triggering method includes:

step S101, determining that there is a need for UE to start an MDT measurement; and

step S102, sending an MDT measurement triggering request through broadcast signaling to trigger the UE to perform the MDT measurement.

The broadcast signaling may be paging signaling or minimum system information (minimum SI). The minimum SI includes a master information block (MIB) and a system information block (SIB) 1.

In an embodiment, sending the MDT measurement triggering request through the broadcast signaling may include but is not limited to the following situations 11) and 12).

In situation 11), first signaling is added into the broadcast signaling; an MDT configuration parameter and at least one of an identity (ID) of the UE needing to start the MDT measurement and an identity of a group (group ID) including the UE needing to start the MDT measurement are added into the first signaling; and the MDT measurement triggering request is sent through the broadcast signaling added with the first signaling.

The first signaling may be new signaling, for example, may be MDT configuration signaling. The MDT configuration parameter may include logged MDT parameter and/or immediate MDT parameter. The logged MDT parameter is configured to trigger logged MDT, and the immediate MDT parameter is configured to trigger immediate MDT.

In situation 12), first signaling is adding into the broadcast signaling; an MDT configuration parameter is added into the first signaling; and then the MDT measurement triggering request is sent through the broadcast signaling added with the first signaling.

The first signaling may be new signaling, for example, may be MDT configuration signaling. The MDT configuration parameter may include a logged MDT parameter and/or an immediate MDT parameter. The logged MDT parameter is configured to trigger a logged MDT measurement, and the immediate MDT parameter is configured to trigger an immediate MDT measurement.

The difference between the above two situations is that in situation 12), the first signaling does not include any UE ID or group ID.

In the above embodiment, if it is determined that the UE needs to start the MDT measurement, the MDT measurement triggering request is sent through the broadcast signaling to trigger the UE to perform the MDT measurement, so that the base station side may obtain UE measurement information for RRM, mobility, and beam management.

For the immediate MDT measurement, the MDT measurement information may be reported after the measurement. For the logged MDT measurement, the MDT measurement may be stored after the measurement, but the MDT measurement information will not be reported immediately.

In order to report the stored MDT measurement information, as shown in FIG. 2, the method may further include:

step S103, determining that there is a need for the UE to report the stored MDT measurement information; and

step S104, sending an MDT measurement information reporting request through the broadcast signaling to trigger the UE to report the stored MDT measurement information.

Second signaling may be added into the broadcast signaling; at least one of an identity of the UE needing to report the MDT measurement information and an identity of a group including the UE needing to report the MDT measurement information is added into the second signaling; and then the MDT measurement information reporting request is sent through the broadcast signaling added with the second signaling.

The second signaling is new signaling, for example, may a stored measurement report (logMeasReport). The signaling may include an ID of a certain UE, or may include a group ID of a group including specific UEs, or may not include any UE ID or group ID.

In the above embodiment, if it is determined that the UE needs to report the stored MDT measurement information, the MDT measurement information reporting request is sent through the broadcast signaling to trigger the UE to report the stored MDT measurement information, so that the base station side may obtain UE measurement information for RRM, mobility, and beam management.

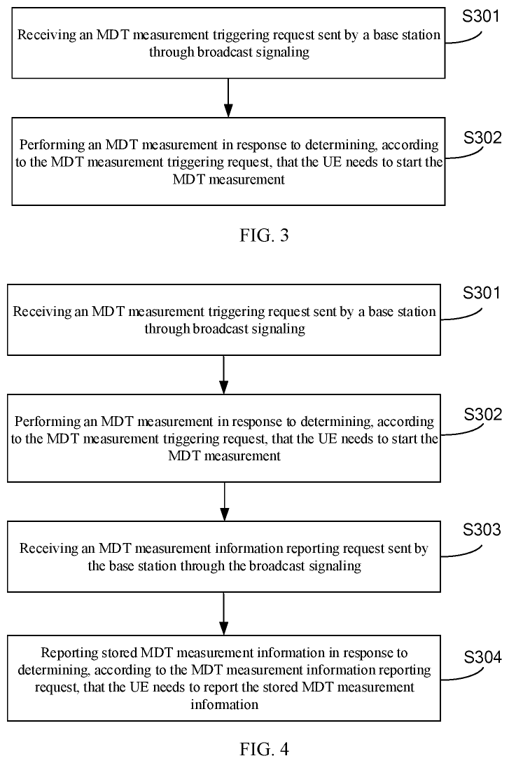

FIG. 3 is a flowchart of a measurement method shown in an embodiment of the present disclosure. The method is described from the UE side. As shown in FIG. 3, the measurement method includes:

step S301, receiving an MDT measurement triggering request sent by a base station through broadcast signaling, wherein the broadcast signaling may be paging signaling or minimum system information (minimum SI), and the minimum SI includes a master information block (MIB) and a system information block (SIB) 1; and

step S302, performing an MDT measurement in response to determining, according to the MDT measurement triggering request, that the UE needs to start the MDT measurement.

Current UE receives the broadcast signaling sent by the base station, and parses out first identity information and an MDT configuration parameter from the broadcast signaling. It may be determined that the UE needs to start the MDT measurement if an identity of the UE is located in the first identity information or the first identity information is empty. Therefore, the MDT measurement may be performed according to the MDT configuration parameter.

In the above embodiment, the minimization of drive test (MDT) measurement triggering request sent by the base station through the broadcast signaling is received, and the MDT measurement is performed when it is determined according to the MDT measurement triggering request that the UE needs to start the MDT measurement, so that the MDT measurement information may be reported to the base station.

FIG. 4 is a flowchart of another measurement method shown in an embodiment of the present disclosure. As shown in FIG. 4, after the above step S102, the method may further include:

step S303, receiving an MDT measurement information reporting request sent by the base station through the broadcast signaling; and

step S304, reporting stored MDT measurement information in response to determining, according to the MDT measurement information reporting request, that the UE needs to report the stored MDT measurement information.

The current UE may receive the broadcast signaling, and parses out second identity information from the broadcast signaling, and the UE determines that the UE itself needs to report the stored MDT measurement information if an identity of the UE is located in the second identity information or the second identity information is empty.

After receiving the MDT measurement information reported by the current UE, the base station may adjust a network parameter based on the MDT measurement information to optimize the network.

In the above embodiment, when the MDT measurement information reporting request sent by the base station through the broadcast signaling is received, and it is determined according to the MDT measurement information reporting request that the UE itself needs to report the stored MDT measurement information, the stored MDT measurement information is reported, so that it can implement that the stored MDT measurement information is reported to the base station side.

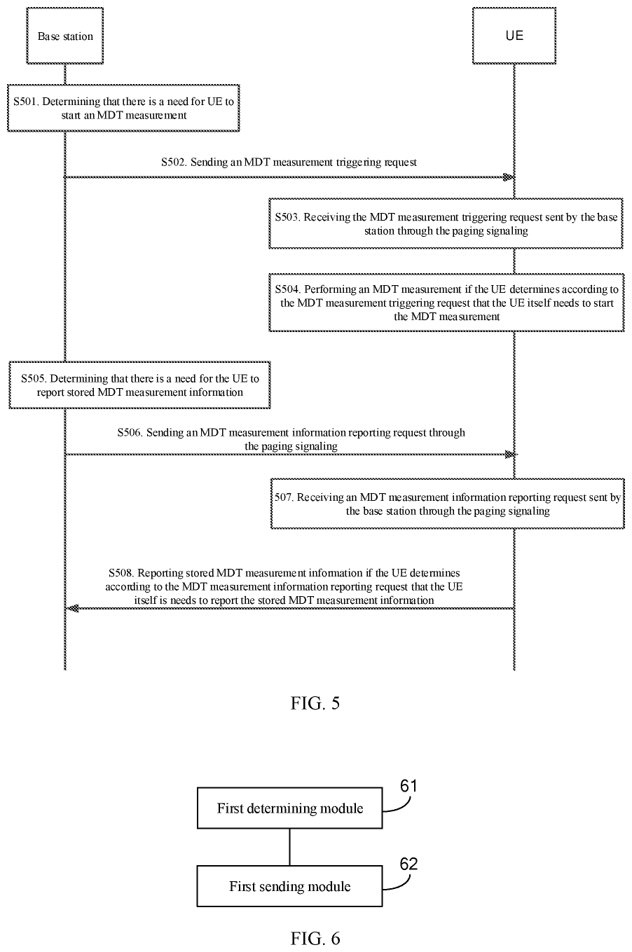

FIG. 5 is a signaling flowchart of a measurement method shown in an embodiment of the present disclosure. An embodiment is described from the perspective of interaction between a base station and UE. As shown in FIG. 5, the method includes:

step S501, determining, by a base station, that there is a need for UE to start an MDT measurement;

step S502, sending, by the base station, an MDT measurement triggering request through paging signaling, wherein the paging signaling carries a UE ID and a logged MDT parameter;

step S503, receiving, by the UE, the MDT measurement triggering request sent by the base station through the paging signaling;

step S504, performing, by the UE, an MDT measurement if the UE determines according to the MDT measurement triggering request that the UE itself needs to start the MDT measurement, wherein if the UE ID carried in the paging signaling is a current UE ID, the UE determines that the UE itself needs to start the MDT measurement, and performs the logged MDT measurement according to the logged MDT parameter;

step S505, determining, by the base station, that there is a need for the UE to report stored MDT measurement information;

step S506, sending, by the base station, an MDT measurement information reporting request through the paging signaling;

step S507, receiving, by the UE, an MDT measurement information reporting request sent by the base station through the paging signaling; and

step S508, reporting, by the UE, stored MDT measurement information if the UE determines according to the MDT measurement information reporting request that the UE itself needs to report the stored MDT measurement information.

In the above embodiment, through the interaction between the base station and the UE, when the UE determines according to the MDT measurement triggering request that the UE itself needs to start the MDT measurement, the UE performs the MDT measurement, and when the UE determines according to the MDT measurement information reporting request that the UE itself needs to report the stored MDT measurement information, the UE reports the stored MDT measurement information, so that the base station can obtain the UE measurement information for rapid RRM, mobility, and beam management.

FIG. 6 is a block diagram showing a measurement triggering device according to an embodiment. The device is located in a base station. As shown in FIG. 6, the device includes:

a first determining module 61, configured to determine that there is a need for user equipment (UE) to start a minimization of drive test (MDT) measurement; and

a first sending module 62, configured to, after the first determining module 61 determines that there is the need for the UE to start the MDT measurement, send an MDT measurement triggering request through broadcast signaling to trigger the UE to perform the MDT measurement.

The broadcast signaling may be paging signaling or minimum system information (minimum SI). The minimum SI includes a master information block (MIB) and a system information block (SIB) 1.

In the above embodiment, if it is determined that the UE needs to start the MDT measurement, the MDT measurement triggering request is sent through the broadcast signaling to trigger the UE to perform the MDT measurement, so that the base station side may obtain UE measurement information for rapid radio resource management (RRM), mobility, and beam management.

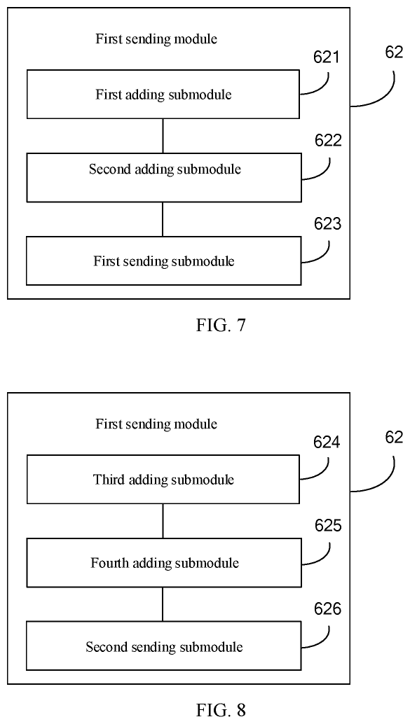

FIG. 7 is a block diagram showing another measurement triggering device according to an embodiment. As shown in FIG. 7, on the basis of the above-mentioned embodiment shown in FIG. 6, the first sending module 62 may include:

a first adding submodule 621, configured to add first signaling into the broadcast signaling;

a second adding submodule 622, configured to add at least one of an identity of the UE needing to start the MDT measurement and an identity of a group including the UE needing to start the MDT measurement, and an MDT configuration parameter into the first signaling added by the first adding submodule 621; and

a first sending submodule 623, configured to send the MDT measurement triggering request through the broadcast signaling added with the first signaling, the first signaling being added with information by the second adding submodule 622.

The first signaling may be new signaling, for example, may be MDT configuration signaling. The MDT configuration parameter may include logged MDT parameter and/or immediate MDT parameter. The logged MDT parameter is configured to trigger logged MDT, and the immediate MDT parameter is configured to trigger immediate MDT.

In the above embodiment, the first signaling is added into the broadcast signaling; the MDT configuration parameter and at least one of the ID of the UE needing to start the MDT measurement and the ID of the group including the UE needing to start the MDT measurement are added into the first signaling; and then the MDT measurement triggering request is sent through the broadcast signaling added with the first signaling, so that it implements the sending of the MDT measurement triggering request through the broadcast signaling.

FIG. 8 is a block diagram showing another measurement triggering device according to an embodiment. As shown in FIG. 8, on the basis of the above-mentioned embodiment shown in FIG. 6, the first sending module 62 may include:

a third adding submodule 624, configured to add first signaling into the broadcast signaling;

a fourth adding submodule 625, configured to add an MDT configuration parameter into the first signaling added by the third adding submodule 624; and

a second sending submodule 626, configured to send the MDT measurement triggering request through the broadcast signaling added with the first signaling, the first signaling being added with information by the fourth adding submodule 625.

The first signaling may be new signaling, for example, may be MDT configuration signaling. The MDT configuration parameter may include a logged MDT parameter and/or an immediate MDT parameter. The logged MDT parameter is configured to trigger a logged MDT measurement, and the immediate MDT parameter is configured to trigger an immediate MDT measurement.

In the embodiment, the first signaling does not include any UE ID or group ID.

In the above embodiment, the first signaling is adding into the broadcast signaling; the MDT configuration parameter is added into the first signaling; and then the MDT measurement triggering request is sent through the broadcast signaling added with the first signaling, so that it implements the sending of the MDT measurement triggering request through the broadcast signaling.

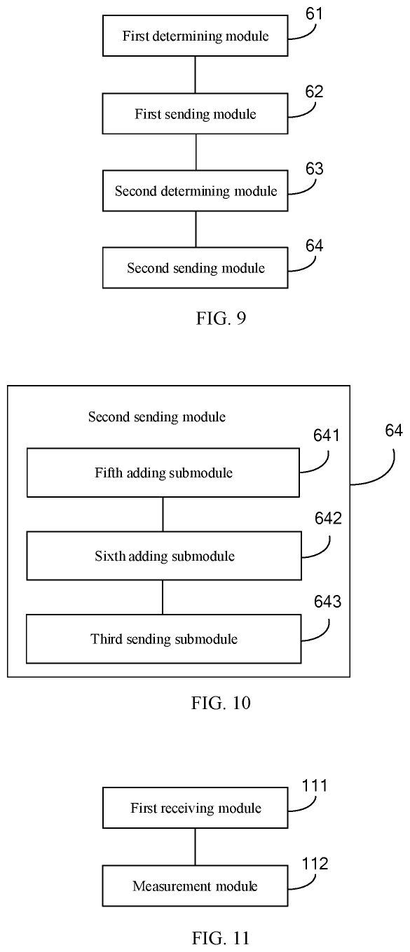

FIG. 9 is a block diagram showing another measurement triggering device according to an embodiment. As shown in FIG. 9, based on the above-mentioned embodiment shown in FIG. 6, the device may further include:

a second determining module 63, configured to determine that there is the need for the UE to report stored MDT measurement information; and

a second sending module 64, configured to, after the second determining module 63 determines that there is the need for the UE to report the stored MDT measurement information, send an MDT measurement information reporting request through the broadcast signaling to trigger the UE to report the stored MDT measurement information.

In the above embodiment, if it is determined that the UE needs to report the stored MDT measurement information, the MDT measurement information reporting request is sent through the broadcast signaling to trigger the UE to report the stored MDT measurement information, so that the base station side may obtain UE measurement information for rapid RRM, mobility, and beam management.

FIG. 10 is a block diagram showing another measurement triggering device according to an embodiment. As shown in FIG. 10, based on the embodiment shown in FIG. 9, the second sending module 64 may include:

a fifth adding submodule 641, configured to add second signaling into the broadcast signaling;

a sixth adding submodule 642, configured to add at least one of an identity of the UE needing to report the MDT measurement information and an identity of a group including the UE needing to report the MDT measurement information into the second signaling added by the fifth adding submodule 642; and

a third sending submodule 643, configured to send the MDT measurement information reporting request through the broadcast signaling added with the second signaling, the second signal being added with information by the sixth adding submodule 642.

The second signaling may be added into the broadcast signaling; at least one of the identity of the UE needing to report the MDT measurement information and the identity of the group including the UE needing to report the MDT measurement information is added into the second signaling; and then the MDT measurement information reporting request is sent through the broadcast signaling added with the second signaling.

The second signaling is new signaling, for example, may a stored measurement report (logMeasReport). The signaling may include an ID of a certain UE, or may include a group ID of a group including specific UEs, or may not include any UE ID or group ID.

In the above embodiment, the second signaling may be added into the broadcast signaling; at least one of the identity of the UE needing to report the MDT measurement information and the identity of the group including the UE needing to report the MDT measurement information is added into the second signaling; and the MDT measurement information reporting request is sent through the broadcast signaling added with the second signaling, so that it implements the sending of the MDT measurement information reporting request through the broadcast signaling.

FIG. 11 is a block diagram showing a measuring device according to an embodiment. The device is located in UE. As shown in FIG. 11, the device includes:

a first receiving module 111, configured to receive a minimization of drive test (MDT) measurement triggering request sent by a base station through broadcast signaling, wherein the broadcast signaling may be paging signaling or minimum system information (minimum SI), and the minimum SI includes a master information block (MIB) and a system information block (SIB) 1; and

a measurement module 112, configured to perform an MDT measurement in response to determining, according to the MDT measurement triggering request received by the first receiving module 111, that the UE needs to start the MDT measurement.

Current UE receives the broadcast signaling sent by the base station, and parses out first identity information and an MDT configuration parameter from the broadcast signaling. It may be determined that the UE needs to start the MDT measurement if an identity of the UE is located in the first identity information or the first identity information is empty. Therefore, the MDT measurement may be performed according to the MDT configuration parameter.

In the above embodiment, the minimization of drive test (MDT) measurement triggering request sent by the base station through the broadcast signaling is received, and the MDT measurement is performed when it is determined according to the MDT measurement triggering request that the UE needs to start the MDT measurement, so that the MDT measurement information may be reported to the base station.

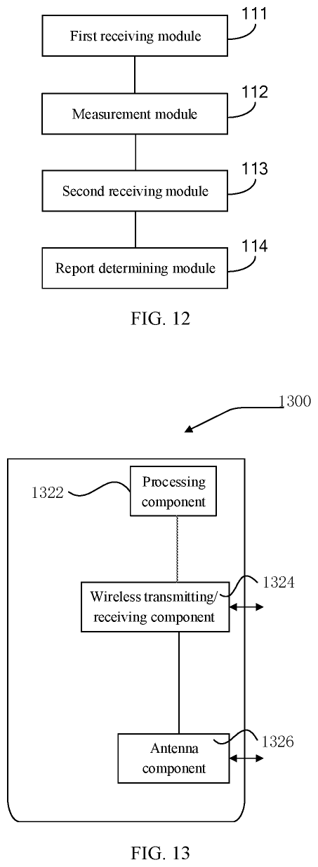

FIG. 12 is a block diagram showing another measurement device according to an embodiment. As shown in FIG. 12, on the basis of the above-mentioned embodiment shown in FIG. 11, the device may further include:

a second receiving module 113, configured to receive an MDT measurement information reporting request sent by the base station through the broadcast signaling; and

a report determining module 114, configured to report stored MDT measurement information in response to determining, according to the MDT measurement information reporting request received by the second receiving module 113, that the UE needs to report the stored MDT measurement information.

The current UE may receive the broadcast signaling, and parses out second identity information from the broadcast signaling, and the UE determines that the UE itself needs to report the stored MDT measurement information if an identity of the UE is located in the second identity information or the second identity information is empty.

After receiving the MDT measurement information reported by the current UE, the base station may adjust a network parameter based on the MDT measurement information to optimize the network.

In the above embodiment, when the MDT measurement information reporting request sent by the base station through the broadcast signaling is received, and it is determined according to the MDT measurement information reporting request that the UE itself needs to report the stored MDT measurement information, the stored MDT measurement information is reported, so that it can implement that the stored MDT measurement information is reported to the base station side.

FIG. 13 is a block diagram showing a device suitable for measurement triggering according to an embodiment. The device 1300 may be provided as a base station. Referring to FIG. 13, the device 1300 includes a processing component 1322, a wireless transmitting/receiving component 1324, an antenna component 1326, and a signal processing part specific to a wireless interface. The processing component 1322 may further include one or more processors.

One of the processors in the processing component 1322 may be configured to:

determine that there is a need for user equipment (UE) to start a minimization of drive test (MDT) measurement; and

send an MDT measurement triggering request through broadcast signaling to trigger the UE to perform the MDT measurement.

An embodiment also provides a non-transitory computer-readable storage medium including instructions, which can be executed by the processing component 1322 of the device 1300 to complete the measurement triggering method described above. For example, the non-transitory computer-readable storage medium may be ROM, random access memory (RAM), CD-ROM, magnetic tape, floppy disk, optical data storage device, and the like.

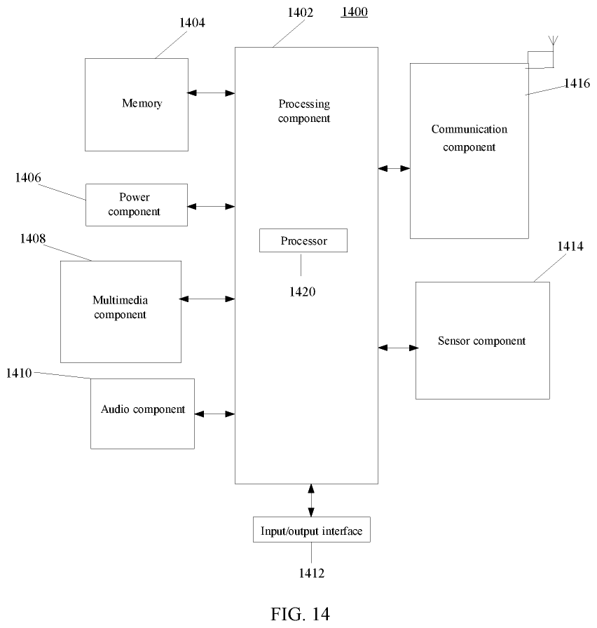

FIG. 14 is a block diagram showing a device suitable for measurement according to an embodiment. For example, the device 1400 may be a mobile phone, a computer, a digital broadcasting terminal, a messaging device, a game console, a tablet device, a medical device, a fitness device, a personal digital assistant, and other user equipment.

Referring to FIG. 14, the device 200 may include one or more of a processing component 1402, a memory 1404, a power component 1406, a multimedia component 1408, an audio component 1410, an input/output (I/O) interface 1412, a sensor component 1414, and a communication component 1416.

The processing component 1402 generally controls the overall operations of the control device 1400, such as operations associated with display, telephone calls, data communications, camera operations, and recording operations. The processing component 1402 may include one or more processors 1420 to execute instructions to complete all or part of the steps of the foregoing method. In addition, the processing component 1402 may include one or more modules to facilitate interaction between the processing component 1402 and other components. For example, the processing component 1402 may include a multimedia module to facilitate the interaction between the multimedia component 1408 and the processing component 1402.

One processor 1420 of the processing component 1402 may be configured to:

receive a minimization of drive test (MDT) measurement triggering request sent by a base station through broadcast signaling; and

perform an MDT measurement in response to determining, according to the MDT measurement triggering request, that the UE needs to start the MDT measurement.

The memory 1404 is configured to store various types of data to support the operation of the device 1400. Examples of these data include instructions for any application or method operating on the device 1400, contact data, phone book data, messages, pictures, videos and the like. The memory 1404 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 1406 provides power to various components of the device 1400. The power component 1406 may include a power management system, one or more power supplies, and other components associated with generating, managing, and distributing power for the device 1400.

The multimedia component 1408 includes a screen that provides an output interface between the device 1400 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 1408 includes a front camera and/or a rear camera. When the device 1400 is in an operation mode, such as a shooting mode or a video mode, the front camera and/or the rear camera can receive external multimedia data. Each front camera and rear camera may be a fixed optical lens system or have focal length and optical zoom capabilities.

The audio component 1410 is configured to output and/or input audio signals. For example, the audio component 1410 includes a microphone (MIC), and when the device 1400 is in an operation mode, such as a call mode, a recording mode, and a voice recognition mode, the microphone is configured to receive an external audio signal. The received audio signal can be further stored in the memory 1404 or sent via the communication component 1416. In some embodiments, the audio component 1410 further includes a speaker for outputting audio signals.

The I/O interface 1412 provides an interface between the processing component 1402 and a peripheral interface module. The above-mentioned peripheral interface module may be a keyboard, a click wheel, a button, and the like. These buttons may include but are not limited to home button, volume button, start button, and lock button.

The sensor component 1414 includes one or more sensors for providing the device 1400 with various aspects of state evaluation. For example, the sensor component 1414 can detect the on/off status of the device 1400 and the relative positioning of components. For example, the component is a display and keypad of the device 1400. The sensor component 1414 can also detect the position change of the device 1400 or a component of the device 1400, the presence or absence of contact between the user and the device 1400, the orientation or acceleration/deceleration of the device 1400, and the temperature change of the device 1400. The sensor component 1414 may include a proximity sensor configured to detect the presence of nearby objects when there is no physical contact. The sensor component 1414 may also include a light sensor, such as a CMOS or CCD image sensor, for use in imaging applications. In some embodiments, the sensor component 1414 may also include an acceleration sensor, a gyroscope sensor, a magnetic sensor, a pressure sensor, or a temperature sensor.

The communication component 1416 is configured to facilitate wired or wireless communication between the device 1400 and other devices. The device 1400 can access a wireless network based on a communication standard, such as WiFi, 2G, or 3G, or a combination thereof. In an embodiment, the communication component 1416 receives a broadcast signal or broadcast related information from an external broadcast management system via a broadcast channel. In an embodiment, the communication component 1416 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 1400 may be implemented by one or more application specific integrated circuits (ASIC), digital signal processors (DSP), digital signal processing device (DSPD), programmable logic devices (PLD), field programmable gate array (FPGA), controller, microcontroller, microprocessor, or other electronic components, used to perform the above-mentioned methods.

An embodiment also provides a non-transitory computer-readable storage medium including instructions, such as the memory 1404 including instructions, and the instructions may be executed by the processor 1420 of the device 1400 to complete the foregoing method. For example, the non-transitory computer-readable storage medium may be ROM, random access memory (RAM), CD-ROM, magnetic tape, floppy disk, optical data storage device and the like.

The technical solutions provided by the embodiments of the present disclosure may include the following beneficial effects.

If it is determined that the UE needs to start the MDT measurement, the MDT measurement triggering request is sent through the broadcast signaling to trigger the UE to perform the MDT measurement, so that the base station side may obtain UE measurement information for RRM, mobility, and beam management.

The minimization of drive test (MDT) measurement triggering request sent by the base station through the broadcast signaling is received, and the MDT measurement is performed when it is determined according to the MDT measurement triggering request that the UE needs to start the MDT measurement, so that the MDT measurement information may be reported to the base station.

Related parts of the device embodiment may refer to the corresponding description in the method embodiment, since the device embodiment basically corresponds to the method embodiment. The device embodiment described above is merely illustrative, where the units described as separate components may or may not be physically separated, and the component displayed as a unit may or may not be a physical unit, that is, it may be located in one place, or it may be distributed onto a plurality of network units. Some or all of the modules may be selected according to actual needs to achieve the objectives of the solutions of the embodiments, which can be understood and implemented by those skilled in the art without creative work.

It should be noted that in the present disclosure, the relational terms such as first and second are only used to distinguish one entity or operation from another entity or operation, and do not necessarily require or imply any actual relationship or sequence between these entities or operations. The terms “include”, “comprise”, or any other variants thereof are intended to cover non-exclusive inclusion, so that a process, method, article or device that includes a series of elements includes not only those elements, but also other elements that are not explicitly listed, or also includes elements inherent to such process, method, article, or device. If there are no more restrictions, an element defined by a sentence “including a . . . ” does not exclude the existence of another identical element in the process, method, article, or device that includes the element.

Those skilled in the art will easily conceive of other embodiments of the present disclosure after considering the specification and practicing the present disclosure disclosed herein. The present application is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The description and the embodiments are to be regarded as exemplary only, and the true scope and spirit of the present disclosure are pointed out by the following claims.

It should be understood that the present disclosure is not limited to the precise structure that has been described above and shown in the drawings, and various modifications and changes can be made without departing from the scope thereof. The scope of the present disclosure is only limited by the appended claims.

1. A measurement triggering method, comprising:
determining, by a base station, that there is a need for a user equipment (UE) to start a minimization of drive test (MDT) measurement; and
sending, by the base station, an MDT measurement triggering request through broadcast signaling to trigger the UE to perform the MDT measurement.

2. The method according to claim 1, wherein sending the MDT measurement triggering request through the broadcast signaling comprises:
adding first signaling into the broadcast signaling;
adding at least one of an identity of the UE needing to start the MDT measurement and an identity of a group comprising the UE needing to start the MDT measurement, and an MDT configuration parameter into the first signaling; and
sending the MDT measurement triggering request through the broadcast signaling added with the first signaling.

3. The method according to claim 1, wherein sending the MDT measurement triggering request through the broadcast signaling comprises:
adding first signaling into the broadcast signaling;
adding an MDT configuration parameter into the first signaling; and
sending the MDT measurement triggering request through the broadcast signaling added with the first signaling.

4. The method according to claim 1, further comprising:
determining that there is a need for the UE to report stored MDT measurement information; and
sending an MDT measurement information reporting request through the broadcast signaling to trigger the UE to report the stored MDT measurement information.

5. The method according to claim 4, wherein sending the MDT measurement information reporting request through the broadcast signaling comprises:
adding second signaling into the broadcast signaling;
adding at least one of an identity of the UE needing to report the MDT measurement information and an identity of a group comprising the UE needing to report the MDT measurement information into the second signaling; and
sending the MDT measurement information reporting request through the broadcast signaling added with the second signaling.

6. The method according to claim 1, wherein the broadcast signaling comprises paging signaling or minimum system information.

7. A measurement method, comprising:
receiving, by a user equipment (UE), a minimization of drive test (MDT) measurement triggering request sent by a base station through broadcast signaling; and
performing, by the UE, an MDT measurement in response to determining, according to the MDT measurement triggering request, that the UE needs to start the MDT measurement.

8. The method according to claim 7, wherein receiving the MDT measurement triggering request sent by the base station through the broadcast signaling comprises:
receiving the broadcast signaling, and parsing out first identity information and an MDT configuration parameter from the broadcast signaling, and
performing the MDT measurement in response to determining, according to the MDT measurement triggering request, that the UE needs to start the MDT measurement comprises:
performing the MDT measurement according to the MDT configuration parameter in response to determining that an identity of the UE is located in the first identity information or the first identity information is empty.

9. The method according to claim 7, further comprising:
receiving an MDT measurement information reporting request sent by the base station through the broadcast signaling; and
reporting stored MDT measurement information in response to determining, according to the MDT measurement information reporting request, that the UE needs to report the stored MDT measurement information.

10. The method according to claim 9, wherein receiving the MDT measurement information reporting request sent by the base station through the broadcast signaling comprises:
receiving the broadcast signaling, and parsing out second identity information from the broadcast signaling, and
determining, according to the MDT measurement information reporting request, that the UE needs to report the stored MDT measurement information comprises:
determining that the UE needs to report the stored MDT measurement information in response to determining that an identity of the UE is located in the second identity information or the second identity information is empty.

11.-20. (canceled)

21. A base station, comprising:
a processor;
a memory storing instructions that, when being executed by the processor, cause the processor to implement acts comprising:
determining that there is a need for a user equipment (UE) to start a minimization of drive test (MDT) measurement; and
sending an MDT measurement triggering request through broadcast signaling to trigger the UE to perform the MDT measurement.

22. A user equipment, comprising:
a processor;
a memory storing instructions that, when being executed by the processor, cause the processor to implement the measurement method according to claim 7.

23.-24. (canceled)

25. The base station according to claim 21, wherein sending the MDT measurement triggering request through the broadcast signaling comprises:
adding first signaling into the broadcast signaling;
adding at least one of an identity of the UE needing to start the MDT measurement and an identity of a group comprising the UE needing to start the MDT measurement, and an MDT configuration parameter into the first signaling; and
sending the MDT measurement triggering request through the broadcast signaling added with the first signaling.

26. The base station according to claim 21, wherein sending the MDT measurement triggering request through the broadcast signaling comprises:
adding first signaling into the broadcast signaling;
adding an MDT configuration parameter into the first signaling; and
sending the MDT measurement triggering request through the broadcast signaling added with the first signaling.

27. The base station according to claim 21, wherein the processor is caused to implement acts further comprising:
determining that there is a need for the UE to report stored MDT measurement information; and
sending an MDT measurement information reporting request through the broadcast signaling to trigger the UE to report the stored MDT measurement information.

28. The base station according to claim 27, wherein sending the MDT measurement information reporting request through the broadcast signaling comprises:
adding second signaling into the broadcast signaling;
adding at least one of an identity of the UE needing to report the MDT measurement information and an identity of a group comprising the UE needing to report the MDT measurement information into the second signaling; and
sending the MDT measurement information reporting request through the broadcast signaling added with the second signaling.

29. The base station according to claim 21, wherein the broadcast signaling comprises paging signaling or minimum system information.

30. The user equipment according to claim 22, wherein receiving the MDT measurement triggering request sent by the base station through the broadcast signaling comprises:
receiving the broadcast signaling, and parsing out first identity information and an MDT configuration parameter from the broadcast signaling, and
performing the MDT measurement in response to determining, according to the MDT measurement triggering request, that the UE needs to start the MDT measurement comprises:
performing the MDT measurement according to the MDT configuration parameter in response to determining that an identity of the UE is located in the first identity information or the first identity information is empty.

31. The user equipment according to claim 22, wherein the processor is caused to implement acts further comprising:
receiving an MDT measurement information reporting request sent by the base station through the broadcast signaling; and
reporting stored MDT measurement information in response to determining, according to the MDT measurement information reporting request, that the UE needs to report the stored MDT measurement information.

32. The user equipment according to claim 31, wherein receiving the MDT measurement information reporting request sent by the base station through the broadcast signaling comprises:
receiving the broadcast signaling, and parsing out second identity information from the broadcast signaling, and
determining, according to the MDT measurement information reporting request, that the UE needs to report the stored MDT measurement information comprises:
determining that the UE needs to report the stored MDT measurement information in response to determining that an identity of the UE is located in the second identity information or the second identity information is empty.
